(19) United States
(12) Patent Application Publication
(10) Pub. No.: US 2022/0129764 A1
(43) Pub. Date: Apr. 28, 2022

(54) ANOMALY DETECTION APPARATUS, ANOMALY DETECTION METHOD, AND COMPUTER-READABLE MEDIUM

(71) Applicant: NEC Corporation, Minato-ku, Tokyo (JP)

(72) Inventor: Satoshi IKEDA, Tokyo (JP)

(73) Assignee: NEC Corporation, Minato-ku, Tokyo (JP)

(21) Appl. No.: 17/431,263

(22) PCT Filed: Feb. 22, 2019
(86) PCT No.: PCT/JP2019/006776

§ 371 Date: Aug. 16, 2021

(51) Int. Cl. G06N 5/00; G06K 9/62

(52) U.S. Cl. CPC G06N 5/003; G06K 9/6262

(57) ABSTRACT

An anomaly detection apparatus according to the present disclosure includes a binary tree structure creation unit, a score calculation unit, and a learning unit. The binary tree structure creation unit creates a binary tree structure using a plurality of data pieces. The score calculation unit calculates a score using a node evaluation value for a node feature vector, the node feature vector being a feature of each node passing from a root node to a leaf node of the binary tree structure. The learning unit learns a node evaluation model for calculating the node evaluation value for the node feature vector of the each node of the binary tree structure.

### TECHNICAL FIELD

The present disclosure relates to an anomaly detection apparatus, an anomaly detection method, and a computer-readable medium, and more particularly to an anomaly detection apparatus, an anomaly detection method, and a computer-readable medium capable of detecting an anomaly using a binary tree structure.

### BACKGROUND ART

The recent development of the information society has increased the importance of cybersecurity. For example, in the field of cybersecurity, it is important to detect unusual data (outliers) in order to detect an anomaly in the data. Isolation Forest is used as one of algorithms used to detect such outliers.

Patent Literature 1 discloses a classification apparatus capable of providing information for evaluating a result of determination made using a classification model of a tree structure. Patent Literature 2 discloses a technique related to a learning apparatus capable of learning a model suitable for identifying time-series data into a plurality of classes.

### CITATION LIST

### Patent Literature

Patent Literature 1: Japanese Unexamined Patent Application Publication No. 2018-045516

Patent Literature 2: Japanese Unexamined Patent Application Publication No. 2016-200971

### SUMMARY OF INVENTION

### Technical Problem

The Isolation Forest algorithm creates a binary tree structure (a separation tree structure) using a plurality of data pieces, and divides the plurality of data pieces using the binary tree structure. The Isolation Forest algorithm uses a path length from a root node to a leaf node as a score, and determines that the smaller the score (the shallower the depth), the more likely the data is to be an outlier (abnormal data).

When the Isolation Forest algorithm is used, in some cases, an expected result cannot be obtained if the distribution of data is unbalanced. That is, in the Isolation Forest algorithm, features (parameters) and thresholds of data to be divided are randomly determined to create a binary tree structure. For this reason, in the case of unbalanced data including a majority data group and a minority data group, data included in the minority data group tends to be determined to be an outlier, and as a result, in some cases, an anomaly in the data cannot be detected as expected.

However, some users may wish to treat data included in such a minority data group as a normal value. Therefore, there is a need for an anomaly detection apparatus capable of reflecting a user's intention.

In view of the above problem, an object of the present disclosure is to provide an anomaly detection apparatus, an anomaly detection method, and a computer-readable medium capable of reflecting a user's intention.

### Solution to Problem

An example aspect of the present disclosure is an anomaly detection apparatus including: a binary tree structure creation unit configured to create a binary tree structure using a plurality of data pieces; a score calculation unit configured to calculate a score using a node evaluation value for a node feature vector, the node feature vector being a feature of each node passing from a root node to a leaf node of the binary tree structure; and a learning unit configured to learn a node evaluation model for calculating the node evaluation value for the node feature vector of the each node of the binary tree structure.

Another example aspect of the present disclosure is an anomaly detection method including: creating a binary tree structure using a plurality of data pieces; calculating a score using a node evaluation value for a node feature vector, the node feature vector being a feature of each node passing from a root node to a leaf node of the binary tree structure; and learning a node evaluation model for calculating the node evaluation value for the node feature vector of the each node of the binary tree structure.

Another example aspect of the present disclosure is a non-transitory computer readable medium storing an anomaly detection program causing a computer to execute: processing of creating a binary tree structure using a plurality of data pieces; processing of calculating a score using a node evaluation value for a node feature vector, the node feature vector being a feature of each node passing from a root node to a leaf node of the binary tree structure; and processing of learning a node evaluation model for calculating the node evaluation value for the node feature vector of the each node of the binary tree structure.

### Advantageous Effects of Invention

According to the present disclosure, it is possible to provide an anomaly detection apparatus, an anomaly detection method, and a computer-readable medium capable of reflecting a user's intention.

### BRIEF DESCRIPTION OF DRAWINGS

FIG. 1 is a block diagram for explaining an anomaly detection apparatus according to an example embodiment;

FIG. 2 is a block diagram for explaining a specific configuration of the anomaly detection apparatus according to the example embodiment;

FIG. 3 is a flowchart for explaining an operation of the anomaly detection apparatus according to the example embodiment;

FIG. 4 is a table showing an example of proxy log data;

FIG. 5 is a table showing an example of the proxy log data converted into feature data;

FIG. 6 shows an example of a binary tree structure;

FIG. 7A is a diagram for explaining an example of a node feature vector;

FIG. 7B is a diagram for explaining an example of the node feature vector;

FIG. 8 is a diagram for explaining another example of the node feature vector;

FIG. 9 is a diagram for explaining an example of machine learning;

FIG. 10 is a diagram for explaining an operation in learning a node evaluation model;

FIG. 11 shows a case in which a distribution of data is unbalanced;

FIG. 12 is a flowchart for explaining an operation of the anomaly detection apparatus according to the example embodiment; and

FIG. 13 is a block diagram showing a computer for executing an anomaly detection processing program according to the present disclosure.

### DESCRIPTION OF EMBODIMENTS

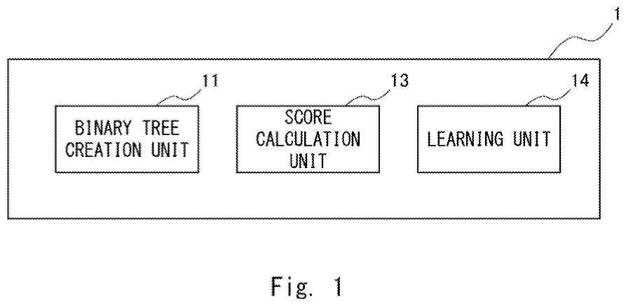

First, an outline of the present disclosure will be described. FIG. 1 is a block diagram for explaining an anomaly detection apparatus according to an example embodiment, and is a diagram for explaining an outline of the present disclosure. The anomaly detection apparatus 1 according to this example embodiment includes a binary tree structure creation unit 11, a score calculation unit 13, and a learning unit 14. The binary tree structure creation unit 11 creates a binary tree structure using a plurality of input data pieces. The score calculation unit 13 calculates a score using a node evaluation value for a node feature vector which is a feature of each node passing from a root node of the binary tree structure created by the binary tree structure creation unit 11 to a leaf node. The learning unit 14 learns a node evaluation model for calculating the node evaluation value for the node feature vector of each node of the binary tree structure.

In the anomaly detection apparatus 1 according to this example embodiment, the node evaluation model for calculating the evaluation value of each node is learned by the learning unit 14. The node evaluation value of each node is determined using a result of the learning. Therefore, it is possible to provide an anomaly detection apparatus, an anomaly detection method, and a computer-readable medium capable of reflecting a user's intention. An example embodiment of the present disclosure will be described in detail below.

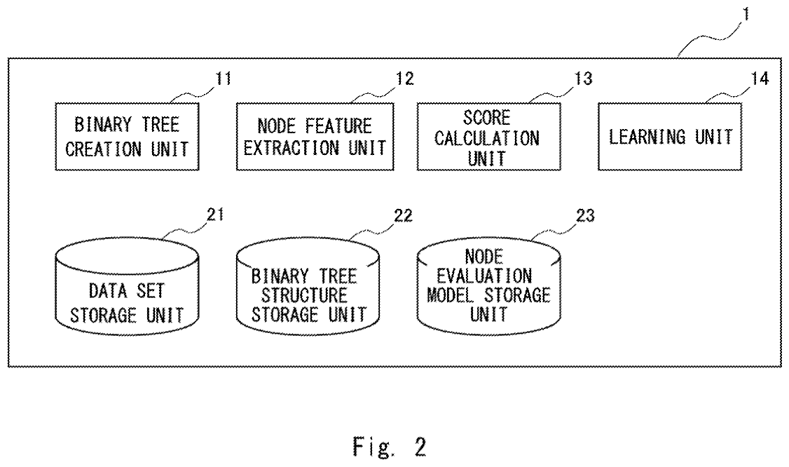

FIG. 2 is a block diagram for explaining a specific configuration of the anomaly detection apparatus according to this example embodiment. As shown in FIG. 2, the anomaly detection apparatus 1 according to this example embodiment includes a binary tree structure creation unit 11, a node feature extraction unit 12, a score calculation unit 13, and a learning unit 14. The anomaly detection apparatus 1 further includes a data set storage unit 21, a binary tree structure storage unit 22, and a node evaluation model storage unit 23.

That is, the binary tree structure creation unit 11 uses the plurality of data pieces (all data pieces or sampled data pieces) to create the binary tree structure. The binary tree structure creation unit 11 randomly selects a dimension (a parameter) and a threshold of the division from the input data pieces to create the binary tree structure. The division may be carried out until the number of leaf nodes of the binary tree structure created at this time becomes a specified number of elements or until the depth of the leaf nodes becomes a predetermined depth (e.g., a specified maximum value).

The node feature extraction unit 12 extracts the node feature vectors of respective nodes of the binary tree structure created by the binary tree structure creation unit 11. Details of the node feature vector will be described later.

The score calculation unit 13 calculates the score using the node evaluation value for the node feature vector which is the feature of each node passing from the root node to the leaf node of the binary tree structure. The score calculated by the score calculation unit 13 indicates a level of normality of the data. More specifically, it is determined that the larger the score, the more normal the data is. Conversely, it is determined that the smaller the score, the more abnormal (i.e., outlier) the data is. For example, the node evaluation value for the node feature vector of each node is a weight of each node based on its node feature vector, and the score calculation unit 13 calculates the score using the weight for the node feature vector of each node passing from the root node to the leaf node of the binary tree structure.

The learning unit 14 learns the node evaluation model for calculating the node evaluation value for the node feature vector of each node of the binary tree structure. In other words, the learning unit 14 learns the node evaluation model for calculating the weight for the node feature vector of each node. For example, the learning unit 14 learns the node evaluation model using machine learning such as deep learning.

The data set storage unit 21 stores a data set for which an anomaly is to be detected. The data set is a collection of data pieces xᵢ represented by a multi-dimensional vector. The data set storage unit 21 also stores a data label indicating one of “normal/abnormal/unknown” for each data piece xᵢ.

The binary tree structure storage unit 22 stores the binary tree structure created by the binary tree structure creation unit 11. Specifically, the binary tree structure storage unit 22 stores information of each node of the binary tree structure created by the binary tree structure creation unit 11. For example, the binary tree structure storage unit 22 stores the node feature vector extracted by the node feature extraction unit 12.

The binary tree structure storage unit 22 stores, for example, the node feature vectors of all nodes. The node feature vector here is a node feature vector nₖ for a node k in the binary tree structure. The binary tree structure storage unit 22 may further store information about “items used for branching”, “threshold of branching”, and “identifier of a child node when the node feature vector is less than/equal to or more than threshold” as information of an intermediate node.

The Isolation Forest algorithm can also create a plurality of the binary tree structures (ensembles). The binary tree structure storage unit 22 manages such plurality of binary tree structures.

The node evaluation model storage unit 23 stores the node evaluation model (a node evaluation function) learned by the learning unit 14. For example, the node evaluation model storage unit 23 can store the learning model (a parameter of the learning model), weights of learning result, and so on.

The anomaly detection apparatus 1 according to this example embodiment may include a display unit (not shown) for displaying the score result calculated by the score calculation unit 13, the anomaly detection result, and so on. For example, the user may input a result of determining whether the data is abnormal or normal for the data with a lower score displayed on the display unit and update the data set.

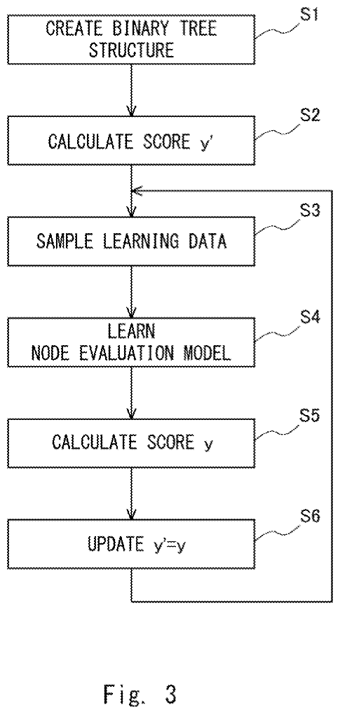

Next, an operation of the anomaly detection apparatus according to this example embodiment (particularly, an operation in a learning phase) will be described. FIG. 3 is a flowchart for explaining the operation of the anomaly detection apparatus according to this example embodiment, and is a flowchart for explaining the operation of the anomaly detection apparatus in the learning phase.

As shown in FIG. 3, the binary tree structure creation unit 11 (see FIG. 2) of the anomaly detection apparatus 1 creates the binary tree structure using the plurality of data pieces (Step S1). That is, the binary tree structure creation unit 11 randomly selects the dimension (the parameter) and the threshold of the division for the plurality of data pieces stored in the data set storage unit 21 to create the binary tree structure. The data pieces of the created binary tree structure are stored in the binary tree structure storage unit 22.

Next, the score calculation unit 13 calculates a score y′ using the node evaluation value for the node feature vector which is the feature of each node passing from the root node to the leaf node of the binary tree structure (Step S2). For example, the node feature vector of each node is extracted using the node feature extraction unit 12. Further, for example, the node evaluation value is the weight for the node feature vector of each node, and the score calculation unit 13 calculates the score using the weight for the node feature vector of each node passing from the root node to the leaf node of the binary tree structure. Hereinafter, the node feature vector and the score calculation processing will be described in detail.

The node feature vector is a feature vector representing characteristics of a node, and can be expressed using statistical information of the data pieces belonging to the node or using information about branch immediately preceding the node (such a branch shall be hereinafter referred to as immediately preceding branch). In addition, as the node feature vector, both the expression using the statistical information of the data belonging to the node and the expression using the immediately preceding branch information may be used.

When the node feature vector is expressed using the statistical information of the data belonging to the node, for example, the node feature vector can be generated using a minimum value and a maximum value of the data piece belonging to each node. That is, for each feature of all data pieces included in the node, the minimum value and the maximum value may be set as the node feature vector. At this time, a median value may be included to reflect the bias of the data in the learning. Further, the node feature vector may be expressed by using statistical information other than the minimum value, maximum value, and median value.

If the statistical information is used, the node feature vector can be expressed by a D×2 matrix (or a D×3 matrix) when the number of dimensions of the data is D. In this case, the node feature vector can be expressed using the following values.

n_{k,d, 1}: a minimum value of a d-th component in the data included in the node k
n_{k, d, 2}: a maximum value of the d-th component in the data included in the node k
n_{k, d, 3}: a median value of the d-th component in the data included in the node k (this value can be optionally selected)

When the node feature vector is expressed using the immediately preceding branch information, the node feature vector can be generated using the parameter in the branch (i.e., the previous node) immediately preceding a target node. For example, the node feature vector can be generated using a feature, a threshold, and a branching direction (whether the node feature vector is less than/equal to or more than) at the branch immediately preceding the target node.

When the node feature vector is expressed using the immediately preceding branch information, the node feature vector can be expressed by a D×3 matrix if the number of dimensions of the data is D. In this case, the node feature vector can be expressed using the following values.

n_{k, d, 1}: “1” if the node is divided by the d-th component, otherwise “0”
n_{k, d, 2}: “threshold” if the node is divided by the d-th component; otherwise, “0”
n_{k, d, 3}: “−1/+1 (less than/equal to or more than)” if the node is divided by the d-th component, otherwise “0”

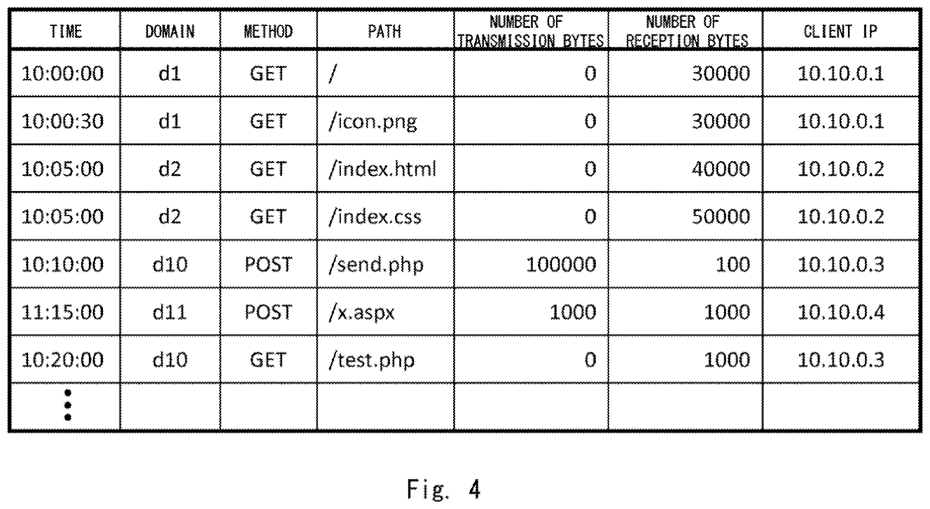

Hereinafter, a method of defining the node feature vector will be described using a specific example. FIG. 4 is a table showing an example of the proxy log data, and shows an example of an access log of a proxy server. The proxy log data shown in FIG. 4 includes information about time, domain, method, path, the number of transmission bytes, the number of reception bytes, and client IP.

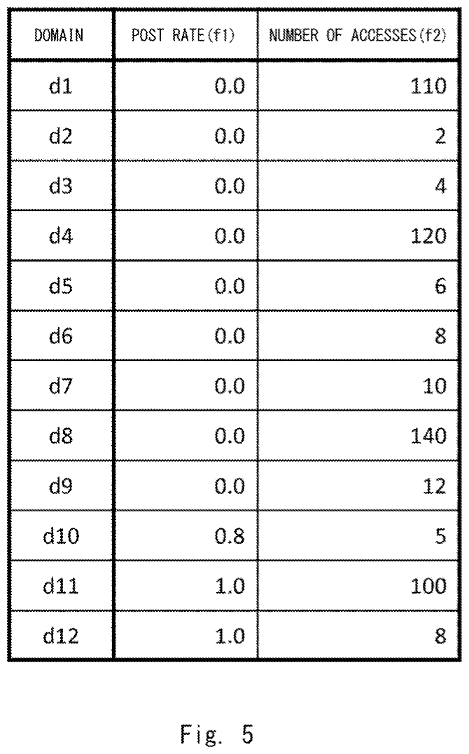

FIG. 5 is a table showing an example in which the proxy log data is converted into feature data. The table shown in FIG. 5 shows a case where a POST rate (f1) and the number of accesses (f2) are extracted for each domain. The POST rate (f1) is a ratio of POST lines to all the methods shown in FIG. 4. The number of accesses (f2) is the total number of lines in the table shown in FIG. 4.

FIG. 5 shows a case where the POST rate (f1) and the number of accesses (f2) are extracted as the node feature vectors for the purpose of simplifying the explanation. However, as the node feature vector, the number of transmission bytes (a minimum value, a maximum value, and an average value), the number of reception bytes (a minimum value, a maximum value, and an average value), the number of access clients, and the like may be used.

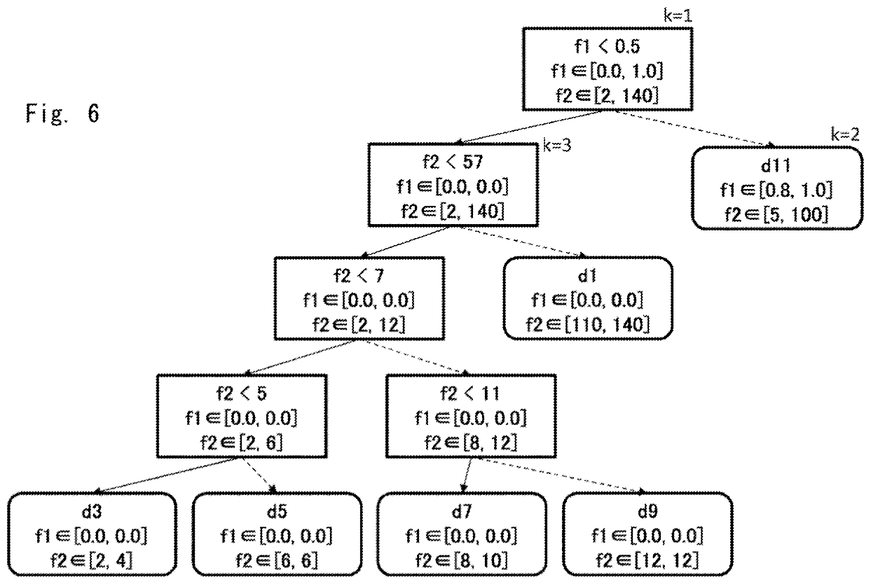

FIG. 6 shows an example in which the binary tree structure is created for the data pieces shown in FIG. 5. FIG. 6 shows a case in which 50% of data pieces shown in FIG. 5 (d1, d3, d5, d7, d9, and d11) is sampled to create the binary tree structure for the purpose of simplifying the explanation. The threshold in each node is an average value of the minimum value and the maximum value of the data included in the node. In the binary tree structure shown in FIG. 6, solid arrows (branches to the left) show cases when conditions are satisfied, while broken arrows (branches to the right) show cases when conditions are not satisfied.

A node (k=1) (k=1 is a node identifier) shown in FIG. 6 corresponds to the root node. The node (k=1) is branched using a feature f1 (POST rate). That is, under the condition “f1<0.5”, if this condition is satisfied, the data included in the node (k=1) is branched to an intermediate node (k=3), whereas if this condition is not satisfied, the data included in the node (k=1) is branched to the leaf node (k=2).

Minimum and maximum values of the feature f1 of the data reaching the node (k=1) among all the data pieces are 0.0 and 1.0, respectively. In FIG. 6, “f1 ∈ [0.0, 1.01]” is described. Similarly, minimum and maximum values of a feature f2 of the data reaching the node (k=1) among all the data are 2 and 140, respectively. In FIG. 6, “f2 ∈ [2, 140]” is described.

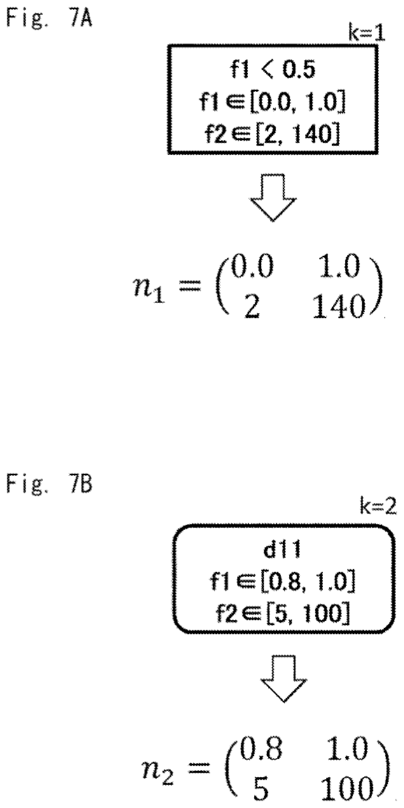

In this case, when the node feature vector of the node (k=1) is expressed using the statistical information of the data belonging to the node, it can be expressed by a 2×2 matrix as shown in FIG. 7A. In a matrix n₁ shown in FIG. 7A, [0.0, 1.0] in the first row corresponds to the minimum and maximum values of the feature f1, respectively, and [2, 140] in the second row corresponds to the minimum and maximum values of the feature f2, respectively.

The node (k=2) shown in FIG. 6 corresponds to the leaf node. Data reaching the node (k=2) among sample data pieces is a data piece of d11. Further, the minimum and maximum values of the feature f1 of the data piece reaching the node (k=2) among all the data pieces are 0.8 and 1.0, respectively. In FIG. 6, “f1 ∈ [0.8, 1.01]” is described. Similarly, the minimum and maximum values of the feature f2 of the data piece reaching the node (k=2) among all the data pieces are 5 and 100, respectively. In FIG. 6, “f2 ∈ [5, 1001]” is described.

In this case, when the node feature vector of the node (k=2) is expressed using the statistical information of the data belonging to the node, it can be expressed by a 2×2 matrix as shown in FIG. 7B. In a matrix n₂ shown in FIG. 7A, [0.8, 1.0] in the first row corresponds to the minimum and maximum values of the feature f1, respectively, and [5, 100] in the second row corresponds to the minimum and maximum values of the feature f2, respectively.

By using the statistical information of the data belonging to the nodes in this manner, the node feature vectors n₁, n₂, . . . of the respective nodes can be expressed.

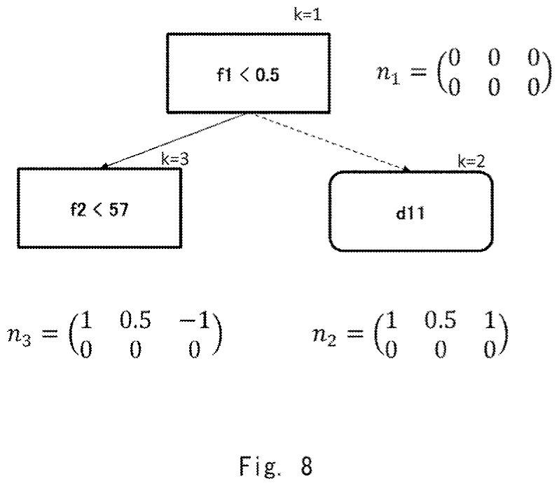

Next, a specific example in which the node feature vector is expressed using the immediately preceding branch information will be described with reference to FIG. 8. FIG. 8 shows the node feature vectors of the node (k=1 to 3) of the binary tree structure shown in FIG. 6 as an example.

As shown in FIG. 8, since there is no immediately preceding branch in the node (k=1), all elements of the matrix of the node feature vector n₁ are set to 0 for convenience.

As shown in FIG. 8, since the branch immediately preceding the node (k=2) is the node (k=1), the node feature vector n₂ of the node (k=2) is generated using the information of the node (k=1). An element of the first row of the node feature vector n₂ corresponds to the feature f1 of the node (k=1) which is the immediately preceding branch. An element of the second row of the node feature vector n₂ corresponds to the feature f2 of the node (k=1) which is the immediately preceding branch.

Since the node (k=1) uses the feature f1 as a branching condition, the element of the first row among the elements of the node feature vector n₂ is [1, 0.5, 1]. Here, the element “1” in the first column of the node feature vector n₂ indicates that the condition of the immediately preceding branch is the feature f1. The element “0.5” in the second column of the node feature vector n₂ indicates that the threshold of the condition of the immediately preceding branch is “0.5”. The element “1” in the third column of the node feature vector n₂ indicates the arrival at the node (k=2), because “f1<0.5” is not satisfied in the condition of the immediately preceding branch (i.e., arrival with “equal to or more than”).

As shown in FIG. 8, since the branch immediately preceding the node (k=3) is the node (k=1), a node feature vector n₃ of the node (k=3) is generated using the information of the node (k=1). An element of the first row of the node feature vector n₃ corresponds to the feature f1 of the node (k=1) which is the immediately preceding branch.

An element of the second row of the node feature vector n₃ corresponds to the feature f2 of the node (k=1) which is the immediately preceding branch.

Since the node (k=1) uses the feature f1 as the branching condition, the element of the first row among the elements of the node feature vector n₃ is [1, 0.5, −1]. Here, the element “1” in the first column of the node feature vector n₃ indicates that the condition of the immediately preceding branch is the feature f1. The element “0.5” in the second column of the node feature vector n₃ indicates that the threshold of the condition of the immediately preceding branch is “0.5”. The element “−1” in the third column of the node feature vector n₃ indicates the arrival at the node (k=3), because “f1<0.5” is satisfied in the condition of the immediately preceding branch (i.e., arrival with “less than”).

By using the immediately preceding branch information in this way, the node feature vectors n₁, n₂, . . . of each node can be expressed.

Next, an operation of calculating the score in Step S2 shown in FIG. 3 will be described in detail. The score calculation unit 13 calculates the score using the node evaluation value for the node feature vector which is the feature of each node passing from the root node to the leaf node of the binary tree structure. Specifically, a score of data x is calculated using a node evaluation value v(n) for a node feature vector m. That is, a score yᵢ is calculated using the following formula.

$${y}_{i} = {\sum }_{k} {I}_{k} ( {x}_{i} ) \cdot v ( {n}_{k} ) . \qquad [ Formula 1 ]$$

In the above formula, xᵢ is a feature vector of i-th data. yᵢ is a score of the i-th data. Iₖ(xᵢ) is a value of “1” if x belongs to the node k, and a value of “0” if x does not belong to the node k. v(nₖ) is the evaluation value (weight) of the node k. nₖ is the feature vector of the node k.

That is, the score calculation unit 13 can calculate the score of the data x by adding the node evaluation values v(n) (weights) of the nodes passing from the root node to the leaf node.

Next, as shown in FIG. 3, the learning unit 14 samples learning data (Step S3). After that, the learning unit 14 learns the node evaluation model using the data sampled in Step S3 (Step S4). After that, the score calculation unit 13 calculates the score y using the learned node evaluation model (i.e., node evaluation v(n)) (Step S5). Then, a value of the score y′ is updated to y, and the processing of Steps S3 to S6 is repeated. The processing of Steps S3 to S6 corresponds to learning processing. Hereinafter, the learning processing of the anomaly detection apparatus according to this example embodiment will be described in detail.

In the anomaly detection apparatus according to this example embodiment, the learning unit 14 learns the node evaluation model so as to separate the score of the data determined to be the outlier from the score that is highly likely to be the normal value. The learning unit 14 learns the node evaluation model so as to separate the score of the data determined to be a normal value from the score that is highly likely to be the outlier.

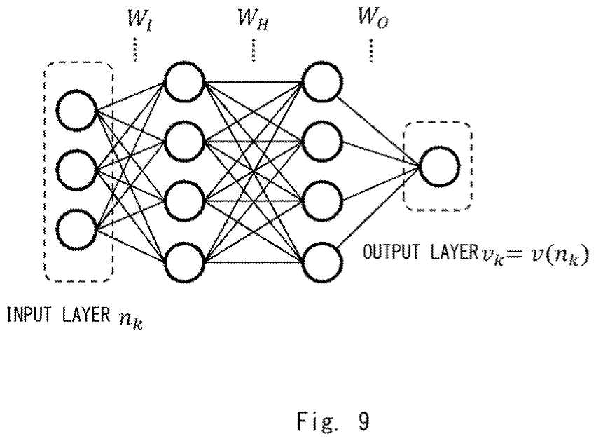

FIG. 9 is a diagram for explaining an example of machine learning, and shows a configuration example of a weight function. In FIG. 9, a neural network is used. In the neural network, the node feature vector ₙₖ of the node k is used as an input layer, and a weight ᵥₖ is used as an output layer. An activation function (sigmoid function, ReLU, etc.) whose value becomes non-negative is used for the output layer vₖ. A function vₖ=v(nₖ) is learned by adjusting weights of layers W_{I}, W_{H}, and W_{O}. DNN (Deep Neural Network) may be used to learn the function v(nₖ).

At this time, in this example embodiment, the node evaluation model may be learned using a loss function including at least one of a hinge loss related to a difference between the score of the data with an abnormal label and that of the data with a higher score and a hinge loss related to a difference between the score of the data with a normal label and that of the data with a lower score. In other words, the node evaluation model can be learned by learning in such a way that the loss function is minimized. The loss function may also include a term for reducing a variation from the previous score.

Specifically, the node evaluation value v(n) for minimizing a loss L expressed by the following formula is learned.

$$L = \frac{1}{\vert {P}_{A} \vert} {\sum }_{i , j ∈ {P}_{A}} {φ}_{{ρ}_{A}} ( {y}_{i} , {y}_{j} ) + \frac{{λ}_{N}}{\vert {P}_{N} \vert} {\sum }_{i , j ∈ {P}_{N}} {φ}_{{ρ}_{N}} ( {y}_{i} , {y}_{j} ) + {λ}_{C} {\sum }_{i} {‖ {y}_{i}^{′} - {y}_{i} ‖}^{2} \\ {φ}_{ρ} ( {y}_{i} , {y}_{j} ) = max ( 0 , {y}_{i} + ρ - {y}_{j} ) \qquad [ Formula 2 ]$$

In the above formula, P_{N} is normal learning data which is a collection using, as an element, a pair of data (i, j) including data j, which is determined to be normal, and data i with a lower score.

P_{A} is abnormal learning data which is a collection using, as an element, a pair of data (i, j) including the data i, which is determined to be abnormal, and the data j with a higher score. λ_{N} and λ_{C} are adjustment parameters. ρ_{A} and ρ_{N} are margins related to the scores of the outlier and normal value, respectively. yᵢ′ is the value of the previous score (note that, at the time of the first learning, the score calculated assuming that all node evaluation values are equal is used).

In the loss function indicating the above loss L, the first term corresponds to “a hinge loss related to a difference between the score of the data with an abnormal label and that of the data with a higher score”. The second term corresponds to “a hinge loss related to a difference between the score of the data with a normal label and that of the data with a lower score”. The third term corresponds to “a term for reducing a variation from the previous score”. In this example embodiment, the node evaluation value v(n) for minimizing the loss L in the loss function is learned.

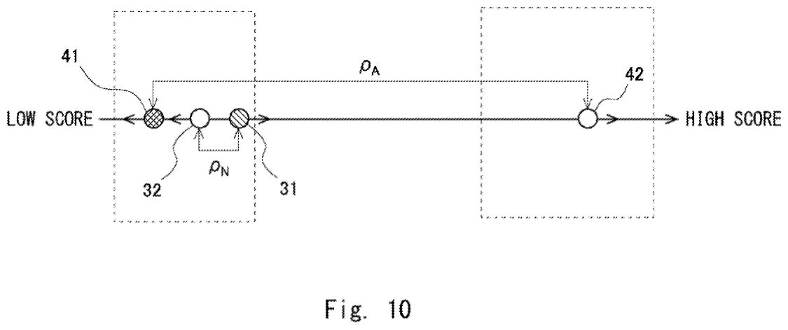

In this example embodiment, the learning data is sampled in Step S3 as follows. That is, the normal learning data P_{N} is generated using, as elements, one or more pairs of (i, j) including the data j determined to be normal and data i sampled from data having a score lower than that of the data j. Further, the abnormal learning data P_{A} is generated using, as elements, one or more pairs of (i, j) including the data i determined to be abnormal and data j sampled from data having a score higher than that of the data i. Specifically, referring to FIG. 10, when data 31 and data 41 are determined to be normal and abnormal, respectively, i(32) is sampled from the data having a score lower than that of the data j(31) determined to be normal. Furthermore, j(42) is sampled from the data having a score higher than that of data i(41) determined to be abnormal.

In this example embodiment, the node evaluation value v(n) is learned by performing the learning processing on the data sampled in this manner. That is, the node evaluation value v(n) that minimizes the loss L of the loss function is learned for the data sampled in this way.

Specifically, with reference to FIG. 10, the data j(31) determined to be normal is shifted to the right so that the score becomes higher (so that the score is shifted to the right direction). For the data i(32) that is highly likely to be the outlier, the score is lowered (shifted to the left). Here, ρ_{N} is a margin related to the score between the score of the data with a lower score and the score of the normal value, and corresponds to a difference between the score of the data with a lower score and the normal value to be maintained (that is, the minimum separation between the scores).

For the data i(41) that is highly likely to be the outlier, the score is lowered (the score is shifted to the left direction). For the data j(42) that is highly unlikely to be the outlier, the score is increased (the score is shifted to the left direction). Here, ρ_{A} is a margin related to the score between the score of the outlier and the score of the data with a higher score, and corresponds to a difference between the score of the outlier and the score of the data with a higher score to be (at least) maintained.

The learning unit 14 can reflect the user's intention in the anomaly detection processing by repeating such learning processing. The node evaluation model learned in the learning unit 14 is stored in the node evaluation model storage unit 23.

As described above, the Isolation Forest algorithm creates the binary tree structure (separation tree structure) using the plurality of data pieces, and divides the plurality of data pieces using the binary tree structure. The Isolation Forest algorithm uses the path length from the root node to the leaf node as the score, and determines that the smaller the score (the shallower the depth), the more likely the data is to be the outlier (abnormal data).

However, with the Isolation Forest algorithm, in some cases, the expected result cannot be obtained if the distribution of data is unbalanced. More specifically, in the Isolation Forest algorithm, features (parameters) and thresholds of data to be divided are randomly determined to create the binary tree structure. For this reason, in the case of unbalanced data including a majority data group and a minority data group, data included in the minority data group tends to be determined to be as outlier, and as a result, in some cases, an anomaly in the data cannot be detected as expected.

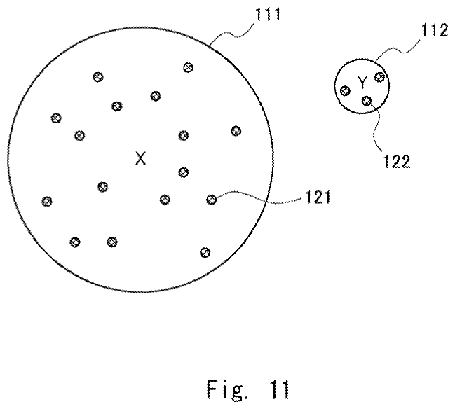

For example, the data group shown in FIG. 11 includes a plurality of data pieces 121 and 122, and these pieces of data are unbalanced data including a majority data group 111 and a minority data group 112. When the Isolation Forest algorithm is applied to such data groups, the data pieces 122 included in the minority data group 112 tend to be determined to be the outliers. Thus, when the Isolation Forest algorithm is applied to unbalanced data, an anomaly in the data cannot be detected as expected in some cases.

However, some users may wish to treat data included in such a minority data group as a normal value. Therefore, there is a need for an anomaly detection apparatus capable of reflecting the user's intention. Here, the user's intention is the user's intention as to whether to treat a specific data group as normal or abnormal, and the contents reflecting the user's policy regarding the handling of data. Such user's intention is reflected when the plurality of data pieces are divided (classified).

In the anomaly detection apparatus 1 according to this example embodiment, as described above, the node evaluation model for calculating the node evaluation value for the node feature vector of each node of the binary tree structure is learned by the learning unit 14. The learning unit 14 can reflect the user's intention in the anomaly detection processing by performing such learning processing. That is, by performing the learning processing while the user's intention is fed back, the user's intention can be reflected in the anomaly detection processing. The user's intention can be reflected using the learning data sampled in Step S3 of FIG. 3. Specifically, the user's intention can be reflected using the normal learning data P_{N} and the abnormal learning data P_{A} which are the learning data.

As described with reference to FIG. 11, when the Isolation Forest algorithm is applied to the unbalanced data, the data included in the minority data group 112 tends to be determined to be the outliers. That is, the score tends to be low, because the minority data group 112 is reached in a shallow division. On the other hand, when the disclosure according to this example embodiment is applied, data included in the minority data group 112 can be learned so that the score thereof can be higher than that of other data.

Further, this example embodiment is characterized in that, since the binary tree structure serves as a constraint of the score, overlearning is less likely to occur. That is, the score of the data belonging to a deep node can be increased.

In this example embodiment, the node evaluation model learned by the learning unit 14 may be reused when the binary tree structure is reconstructed. That is, when there is a change in the data set due to an increase in data or the like, the binary tree structure is reconstructed as necessary, but at this time, the learned node evaluation model may be used.

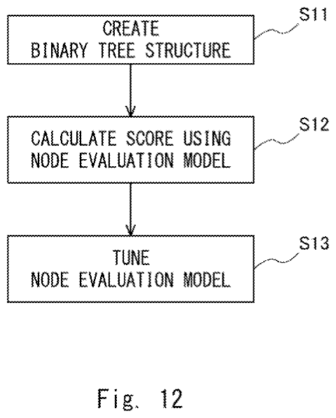

FIG. 12 is a flowchart for explaining the operation of the anomaly detection apparatus according to this example embodiment, and is a flowchart for explaining the operation when the binary tree structure is reconstructed. As shown in FIG. 12, when the binary tree structure is reconstructed, the binary tree structure creation unit 11 (see FIG. 2) of the anomaly detection apparatus 1 creates a binary tree structure using a data set for reconstruction (Step S11).

Next, the score calculation unit 13 calculates the score using the node evaluation value for the node feature vector which is the feature of each node passing from the root node to the leaf node of the binary tree structure (Step S12). At this time, the score calculation unit 13 calculates the score by reusing the learned node evaluation model.

After that, the learning unit 14 tunes the node evaluation model (Step S13). That is, the node evaluation model is tuned according to the new data set by performing the learning processing of Steps S3 to S6 shown in FIG. 3. At this time, the tuning may be performed using teacher data. If the tuning processing of Step S13 is unnecessary, it may be omitted as appropriate.

In this manner, when the binary tree structure is created for the new data set, the learned node evaluation model is reused to reduce a load of arithmetic processing.

In the above-described example embodiment, a single binary tree structure is used for the purpose of simplifying the explanation, but the present disclosure is not limited to this. That is, a plurality of binary tree structures may be used. In this case, instead of learning the node evaluation model for each binary tree structure, one node evaluation model can be learned for all binary tree structures. Even when the plurality of binary tree structures are used, the score of the data can be calculated as a sum of the node evaluation values passing all the binary tree structures using the formula for calculating the score yᵢ.

In the above example embodiment, the present disclosure has been described as a hardware configuration, but the present disclosure is not limited thereto. According to the present disclosure, the anomaly detection processing can also be implemented by causing a CPU (Central Processing Unit), which is a processor, to execute a computer program.

That is, a program for the executing anomaly detection processing may be executed by a computer, in which the anomaly detection processing includes processing for creating the binary tree structure using the plurality of data pieces, processing for calculating the score using the node evaluation value for the node feature vector of each node passing from the root node to the leaf node of the binary tree structure, and processing for learning the node evaluation model for calculating the evaluation value of each node using the node feature vector which is the feature of each node of the binary tree structure.

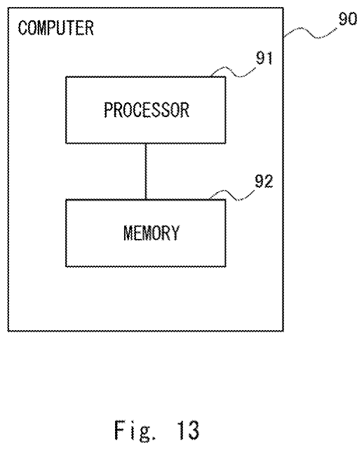

FIG. 13 is a block diagram showing a computer for executing the anomaly detection processing program according to the present disclosure. As shown in FIG. 13, a computer 90 includes a processor 91 and a memory 92. The program for anomaly detection processing is stored in the memory 92. The processor 91 reads the program for anomaly detection processing from the memory 92. Then, by the processor 91 executing the program for the anomaly detection processing, the anomaly detection processing according to the present disclosure described above can be executed.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The whole or part of the exemplary embodiments disclosed above can be described as, but not limited to, the following supplementary notes.

### (Supplementary Note 1)

An anomaly detection apparatus comprising:

a binary tree structure creation unit configured to create a binary tree structure using a plurality of data pieces;

a score calculation unit configured to calculate a score using a node evaluation value for a node feature vector, the node feature vector being a feature of each node passing from a root node to a leaf node of the binary tree structure; and

a learning unit configured to learn a node evaluation model for calculating the node evaluation value for the node feature vector of the each node of the binary tree structure.

### (Supplementary Note 2)

The anomaly detection apparatus according to Supplementary note 1, wherein

the node evaluation value for the node feature vector of the each node is a weight for the node feature vector of the each node,

the score calculation unit is configured to calculate the score using the weight for the node feature vector of the each node passing from the root node to the leaf node of the binary tree structure, and

the learning unit is configured to learn the node evaluation model for calculating the weight for the node feature vector of the each node;

### (Supplementary Note 3)

The anomaly detection apparatus according to Supplementary note 1 or 2, wherein

the node feature vector is generated using statistical information of data belonging to the each node.

### (Supplementary Note 4)

The anomaly detection apparatus according to Supplementary note 3, wherein

the node feature vector is generated using a minimum value and a maximum value of the data belonging to the each node.

### (Supplementary Note 5)

The anomaly detection apparatus according to Supplementary note 1 or 2, wherein

the node feature vector is generated using a parameter in a branch immediately preceding a target node.

### (Supplementary Note 6)

The anomaly detection apparatus according to Supplementary note 5, wherein

the node feature vector is generated using a feature, a threshold, and a branching direction in the branch immediately preceding the target node.

### (Supplementary Note 7)

The anomaly detection apparatus according to any one of Supplementary notes 1 to 6, wherein

the learning unit is configured to learn the node evaluation model so as to separate the score of data determined to be an outlier from the score which is highly likely to be a normal value.

### (Supplementary Note 8)

The anomaly detection apparatus according to any one of Supplementary notes 1 to 7, wherein

the learning unit is configured to learn the node evaluation model so as to separate the score of the data determined to be the normal value from the score which is highly likely to be the outlier.

### (Supplementary Note 9)

The anomaly detection apparatus according to any one of Supplementary notes 1 to 8, wherein the learning unit is configured to learn the node evaluation model by minimizing a loss function including at least one of a hinge loss related to a difference between the score of data provided with an abnormal label and the score of data provided with a higher score and a hinge loss related to a difference between the score of data with a normal label and the score of data with a lower score.

### (Supplementary Note 10)

The anomaly detection apparatus according to Supplementary note 9, wherein

the loss function includes a term for reducing a variation from a previous score.

### (Supplementary Note 11)

An anomaly detection method comprising:

creating a binary tree structure using a plurality of data pieces;

calculating a score using a node evaluation value for a node feature vector, the node feature vector being a feature of each node passing from a root node to a leaf node of the binary tree structure; and

learning a node evaluation model for calculating the node evaluation value for the node feature vector of the each node of the binary tree structure.

### (Supplementary Note 12)

A non-transitory computer readable medium storing an anomaly detection program causing a computer to execute:

processing of creating a binary tree structure using a plurality of data pieces;

processing of calculating a score using a node evaluation value for a node feature vector, the node feature vector being a feature of each node passing from a root node to a leaf node of the binary tree structure; and

processing of learning a node evaluation model for calculating the node evaluation value for the node feature vector of the each node of the binary tree structure.

Although the present disclosure has been described with reference to the above example embodiment, the present disclosure is not limited to the configuration of the above example embodiment, and obviously includes various modifications, changes, and combinations that can be made by a person skilled in the art within the scope of the claimed disclosure.

### REFERENCE SIGNS LIST

1 ANOMALY DETECTION APPARATUS
11 BINARY TREE STRUCTURE CREATION UNIT
12 NODE FEATURE EXTRACTION UNIT
13 SCORE CALCULATION UNIT
14 LEARNING UNIT
21 DATA SET STORAGE UNIT
22 BINARY TREE STRUCTURE STORAGE UNIT
23 NODE EVALUATION MODEL STORAGE UNIT
90 COMPUTER
91 PROCESSOR
92 MEMORY

What is claimed is:

1. An anomaly detection apparatus comprising:
a binary tree structure creation unit configured to create a binary tree structure using a plurality of data pieces;
a score calculation unit configured to calculate a score using a node evaluation value for a node feature vector, the node feature vector being a feature of each node passing from a root node to a leaf node of the binary tree structure; and
a learning unit configured to learn a node evaluation model for calculating the node evaluation value for the node feature vector of the each node of the binary tree structure.

2. The anomaly detection apparatus according to claim 1, wherein
the node evaluation value for the node feature vector of the each node is a weight for the node feature vector of the each node,
the score calculation unit is configured to calculate the score using the weight for the node feature vector of the each node passing from the root node to the leaf node of the binary tree structure, and
the learning unit is configured to learn the node evaluation model for calculating the weight for the node feature vector of the each node;

3. The anomaly detection apparatus according to claim 1, wherein
the node feature vector is generated using statistical information of data belonging to the each node.

4. The anomaly detection apparatus according to claim 3, wherein
the node feature vector is generated using a minimum value and a maximum value of the data belonging to the each node.

5. The anomaly detection apparatus according to claim 1, wherein
the node feature vector is generated using a parameter in a branch immediately preceding a target node.

6. The anomaly detection apparatus according to claim 5, wherein
the node feature vector is generated using a feature, a threshold, and a branching direction in the branch immediately preceding the target node.

7. The anomaly detection apparatus according to claim 1, wherein
the learning unit is configured to learn the node evaluation model so as to separate the score of data determined to be an outlier from the score which is highly likely to be a normal value.

8. The anomaly detection apparatus according to claim 1, wherein
the learning unit is configured to learn the node evaluation model so as to separate the score of the data determined to be the normal value from the score which is highly likely to be the outlier.

9. The anomaly detection apparatus according to claim 1, wherein
the learning unit is configured to learn the node evaluation model by minimizing a loss function including at least one of a hinge loss related to a difference between the score of data provided with an abnormal label and the score of data provided with a higher score and a hinge loss related to a difference between the score of data with a normal label and the score of data with a lower score.

10. The anomaly detection apparatus according to claim 9, wherein
the loss function includes a term for reducing a variation from a previous score.

11. An anomaly detection method comprising:
creating a binary tree structure using a plurality of data pieces;
calculating a score using a node evaluation value for a node feature vector, the node feature vector being a feature of each node passing from a root node to a leaf node of the binary tree structure; and
learning a node evaluation model for calculating the node evaluation value for the node feature vector of the each node of the binary tree structure.

12. A non-transitory computer readable medium storing an anomaly detection program causing a computer to execute:
processing of creating a binary tree structure using a plurality of data pieces;
processing of calculating a score using a node evaluation value for a node feature vector, the node feature vector being a feature of each node passing from a root node to a leaf node of the binary tree structure; and
processing of learning a node evaluation model for calculating the node evaluation value for the node feature vector of the each node of the binary tree structure.
